(19) United States
(12) Patent Application Publication
(10) Pub. No.: US 2026/0111816 A1
(43) Pub. Date: Apr. 23, 2026

(54) SYSTEMS AND METHODS FOR AUTOMATIC AGENT GENERATION

(71) Applicant: GE Precision Healthcare LLC, Waukesha, WI (US)

(72) Inventors: Sundar Balasubramanian, Seattle, WA (US); Md Atiur Rahman Siddique, Bothell, WA (US); Le Huang, Redmond, WA (US); Mengmeng Zhu, Redmond, WA (US); George Cheng, Seattle, WA (US); Parminder Bhatia, Seattle, WA (US); Taha Kass-Hout, Seattle, WA (US); Anit Kumar Sahu, Redmond, WA (US)

(21) Appl. No.: 19/193,760

(22) Filed: Apr. 29, 2025

Related U.S. Application Data
(60) Provisional application No. 63/709,365, filed on Oct. 18, 2024.

(51) Int. Cl. G06Q 10/0631; G06F 9/50; G06Q 10/0639

(52) U.S. Cl. CPC G06Q 10/06316; G06F 9/5027; G06Q 10/06393

(57) ABSTRACT

Methods and systems are provided for automatically generating an artificial intelligence (AI) agent using one or more large language models (LLMs), based on functional instructions provided by a subject matter expert without the input of technical or software engineering experts. The subject matter expert may submit a task description and one or more additional instructions for generating the AI agent to an automated AI agent generator. The AI agent generator select an appropriate LLM, and may submit the task description and the additional instructions as prompts to the selected LLM to generate the AI agent. Additionally, the subject matter expert may submit a query to the AI agent generator, and the AI agent generator may use a selector agent to select one or more AI agents of a plurality of AI agents of an existing agentic system to answer the query or to perform tasks included in the query.

### CROSS REFERENCE TO RELATED APPLICATIONS

The present application claims priority to U.S. Provisional Application No. 63/709,365, entitled “SYSTEMS AND METHODS FOR AUTOMATIC AGENT GENERATION”, and filed on Oct. 18, 2024. The entire contents of the above-listed application are hereby incorporated by reference for all purposes.

### TECHNICAL FIELD

Embodiments of the subject matter disclosed herein relate to generating artificial intelligence (AI) based agents using generative AI.

### BACKGROUND

An artificial intelligence (AI) agent is a software program that is an abstraction of a human expert, meant to be skilled at performing a certain kind of task or analysis. An AI agent can be generated using an LLM (large language model), by submitting a series of prompts describing a desired structure of the agent and desired functionality of the agent. However, the details of how the prompts are written are a highly influential variable of overall agent utility. An appropriate LLM must be selected, as well as one or more other models (foundation models, classification models, predictive models, etc.), data sources (source data & vectorized data), and potentially various tools that can be accessed via API. The functionality of the agent is most accurately described by a domain subject matter expert who may have little experience in software engineering, but the design of the software may be a highly technical exercise involving machine learning engineers and software engineers. Forcing real time collaboration between these different groups can be cost-prohibitive and can result in details being overlooked.

### SUMMARY

The current disclosure addresses the issues described above with an AI agent generation system, comprising an agent generator including a processor communicably coupled to a non-transitory memory including instructions that when executed, cause the processor to receive a task description of a computerized task to be performed within a health care system and instructions for generating an AI agent to perform the task from a user of the agent generator; receive a selection of a template for the AI agent of a plurality of templates from the user; select a large language model (LLM) of a plurality of LLMs stored in a cloud, based on the task description and the instructions; submit one or more prompts including the task description and the instructions to the selected LLM to generate a program for creating the AI agent, based on the selected template; and execute the program to generate the AI agent and allocate processing resources to the AI agent; store the program and/or the AI agent in the non-transitory memory as part of an agentic system, the agentic system including a plurality of AI agents having different allocations of processing resources; and perform the computerized task using the generated AI agent. The LLM may be selected based on a pricing of AI services including the LLMs, a success rate of an LLM on similar types of tasks, or an output of a predictive machine learning (ML) model. The instructions for generating the AI agent may include, for example, data sources available for the AI agent to use, including operational data, policies, cost and/or pricing data, key performance indicators (KPIs), and reference materials of the health care system; resources available to be used by the AI agent in performing the task, such as an LLM for the AI agent to submit prompts to, business intelligence and/or simulation software tools, AI models to use, and the like; a specification of one or more target agents that the AI agent interacts with in performing the task; or other instructions.

Additionally, in some examples, the LLM may be provided instructions for assuming a role of a software engineer designing the AI agent for performing the computerized task, and the LLM may be prompted to generate the AI agent based on the task description while performing the role of the software engineer. The LLM may output text including instructions for creating the AI agent programmatically and allocating processing resources for the AI agent, which may be executed to create the AI agent.

The above advantages and other advantages, and features of the present description will be readily apparent from the following Detailed Description when taken alone or in connection with the accompanying drawings. It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

Various aspects of this disclosure may be better understood upon reading the following detailed description and upon reference to the drawings in which:

FIG. 1 shows a block schematic diagram of an exemplary automated AI agent generation system;

FIG. 2 shows a block schematic diagram of an exemplary flow of data within the automated agent generation system;

FIG. 3 is a flowchart showing an exemplary high-level method for generating a generic AI agent using an LLM;

FIG. 4 is a flowchart showing an exemplary method for generating a fact-checking AI agent using an LLM;

FIG. 5 is a flowchart showing an exemplary method for generating a resource allocation AI agent using an LLM;

FIG. 6 is a flowchart showing an exemplary method for generating a network planning AI agent using an LLM;

FIG. 7 is an exemplary task description for generating the fact-checking AI agent;

FIG. 8 is an exemplary task description for generating the resource allocation AI agent;

FIG. 9 is an exemplary task description for generating the network planning AI agent;

FIG. 10 is an exemplary task description for generating a cost forecasting AI agent; and

FIG. 11 is a flowchart showing an exemplary method for selecting one or more existing AI agents of an AI agent generation system for performing a task.

The drawings illustrate specific aspects of the described systems and methods. Together with the following description, the drawings demonstrate and explain the structures, methods, and principles described herein. In the drawings, the size of components may be exaggerated or otherwise modified for clarity. Well-known structures, materials, or operations are not shown or described in detail to avoid obscuring aspects of the described components, systems and methods.

### DETAILED DESCRIPTION

Methods and systems are provided herein for automatically generating an artificial intelligence (AI) agent using one or more large language models (LLM). As used herein, an AI agent is a software program that when executed may perform one or more computerized tasks within a defined system in which it runs or information ecosystem, such as a health care system. In various embodiments, performing the one or more computerized tasks may include submitting prompts to an LLM of the one or more LLMs, receiving responses back from the LLM, and performing actions or tasks based on the responses.

One common problem in tasking an LLM to design an AI agent is that functional details about a task desired to be performed by the AI agent may be most appropriately specified a first person or group of people (e.g., subject matter experts), and technical details regarding how a software implementation should be designed to support the desired functionality of the AI agent may be most appropriately specified by a second person or group of people (e.g., a software engineer, machine learning engineer, product manager, etc.). Thus, a success of the AI agent at performing the task typically depends on the cooperation of various individuals, which may be difficult to achieve both logistically and due to communication problems resulting from non-overlapping skillsets.

To address this problem, an automated AI agent generation system is provided herein, where AI agents may be generated based on functional instructions provided by a subject matter expert without the input of technical or engineering experts and stored in a memory of the AI agent generation system, forming an agentic system. To accomplish this, systems and methods are proposed for generating a series of prompts that can be submitted to an LLM that result in the creation of an AI agent with a suitable technical implementation for performing the desired task. As a result, a subject matter expert may use the automated AI agent generation system to generate AI agents without having to rely on expertise provided by technical experts.

The subject matter expert may submit a task description and one or more additional instructions for generating the AI agent to an automated AI agent generator of the AI agent generation system. In some examples, a template for implementing the AI agent may be selected by the user or by the AI agent generator, based on the task description and/or instructions. The AI agent generator may be communicatively coupled to a plurality of LLMs hosted at commercial AI services available to the public, such as OPENAI's GPT. The AI agent generator may select a suitable LLM of the plurality of LLMs, and submit the task description and the additional instructions as prompts to the selected LLM. The LLM may output programming code for creating the AI agent based on the task description, the additional instructions, and/or the template, and the AI agent generator may execute the code to generate the AI agent and allocate processing and/or memory resources for the AI agent. The programming code and/or the AI agent may be stored in a memory of the agent generator as part of the agentic system. The instructions may specify resources, data, and tools to be used by the LLM in creating the AI agent, and/or to be used by the AI agent in performing the task. For example, the instructions may specify policies to adhere to, internal models of the automated AI agent generation system to consult, databases where data relevant to the task is stored, business intelligence tools to use, and so on. The instructions may also specify an allocation of processing and/or memory resources for the AI agent for performing the task. Various AI agents may be stored in the agentic system, where different AI agents of the various AI agents may be allocated different amounts of processing and/or memory resources to manage an efficiency of the AI agent generation system. For example, some AI agents may be created to perform tasks that are more computationally demanding than other AI agents. In various embodiments, the subject matter expert may create the instructions with the aid of tools, user interfaces (UIs) and/or agents of the AI agent generation system.

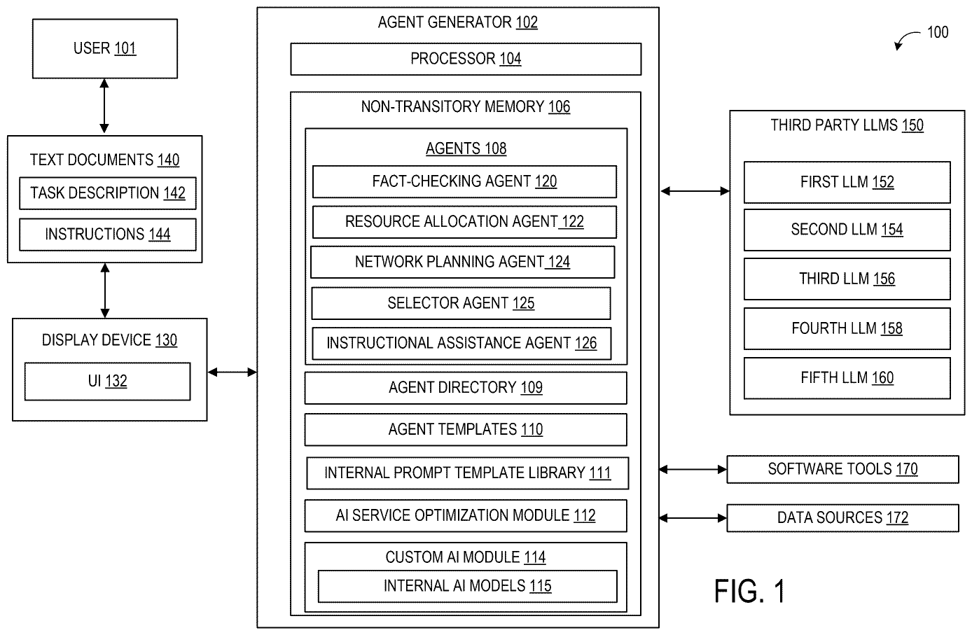

FIG. 1 shows an exemplary agent generation system 100, including an agent generator 102 and a plurality of third-party LLMs 150. As described in greater detail below, agent generator 102 may follow an automated process to generate one or more AI agents 108 (also referred to herein as agents) tailored to a specific task description inputted into agent generator 102. In the examples provided herein, agent generation system 100 is implemented within a health care system, and the AI agents generated by agent generator 102 may analyze data and/or perform computerized tasks within information systems of the health care system.

The one or more AI agents 108 may be generated by agent generator 102 based on information supplied in one or more text documents 140. In various embodiments, text documents 140 include a task description 142 and additional instructions 144. Text documents 120 may be submitted to agent generator 102 by a user 101, who may be a subject matter expert in a domain of task description 142. In other words, based on task description 142 and instructions 144, agent generator 102 may generate the one or more agents automatically without additional input by user 101.

For example, a manager of a health care unit of a hospital may use the agent generation system 100 to generate an agent tasked with predicting a probability that a new patient could be admitted into the unit in the next 24 hours, based on information about patients of the hospital stored in a database. The agent may be instructed to perform a plurality of simulations of various scenarios that could affect the prediction, using statistical, probabilistic, or neural network models accessible to the agent. As another example, the manage may use the agent generation system 100 to generate a second agent tasked with proposing various options for how budgeted funds could most efficiently be spent in purchasing new equipment, given certain priorities and criteria.

Text documents 120 may be submitted to agent generator 102 via a user interface (UI) 132 displayed on a display device 130. In some examples, display device 130 may be a display device of agent generator 102 (e.g., a computer screen or display terminal). In other examples, display device 130 may be a computer device of user 101, such as a personal computer, laptop, tablet, smart phone, etc. UI 132 may be generated by agent generator 102, via a standalone application, a web browser, or similar technology. After agent generator 102 has generated an agent from task description 142 and instructions 144, user 101 may interact with the agent in UI 132 on display device 130.

Agent generator 102 includes a processor 104 and a non-transitory memory 106. Processor 104 may be configured to execute machine readable instructions stored in non-transitory memory 106. Processor 104 may be single core or multi-core, and the programs executed thereon may be configured for parallel or distributed processing. In some embodiments, processor 104 may optionally include individual components that are distributed throughout two or more devices, which may be remotely located and/or configured for coordinated processing. In some embodiments, one or more aspects of processor 104 may be virtualized and executed by remotely-accessible networked computing devices configured in a cloud computing configuration.

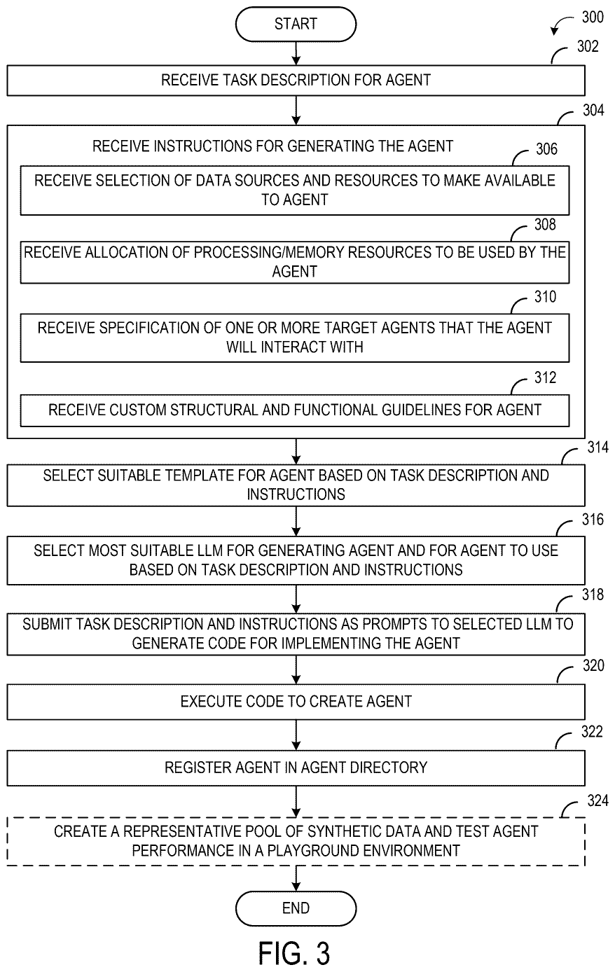

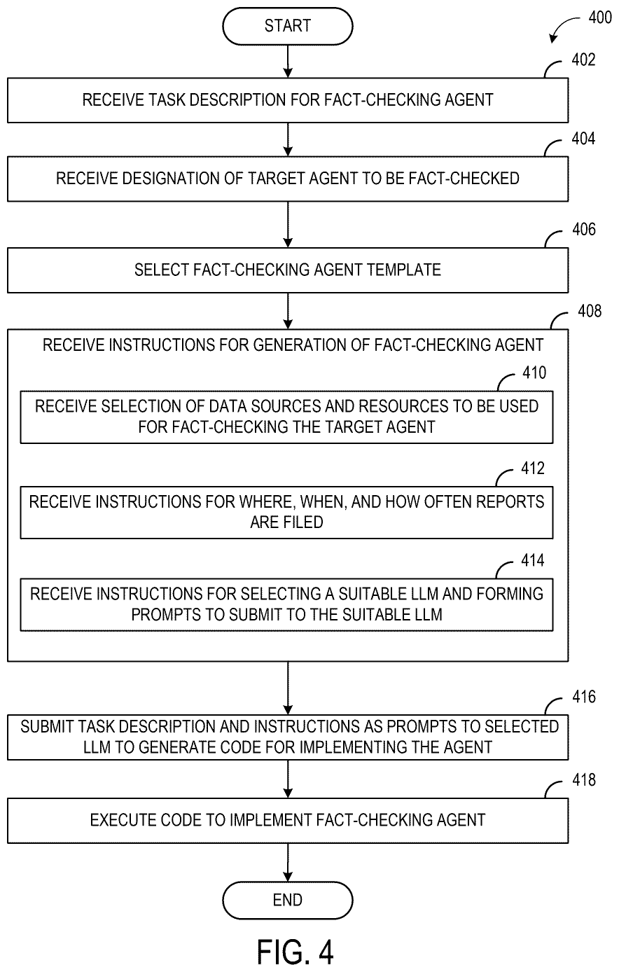

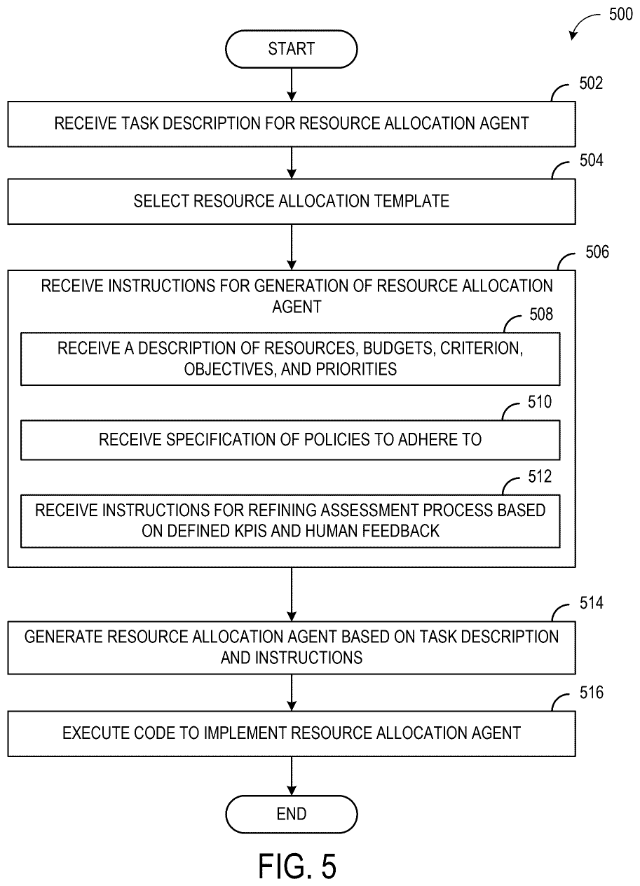

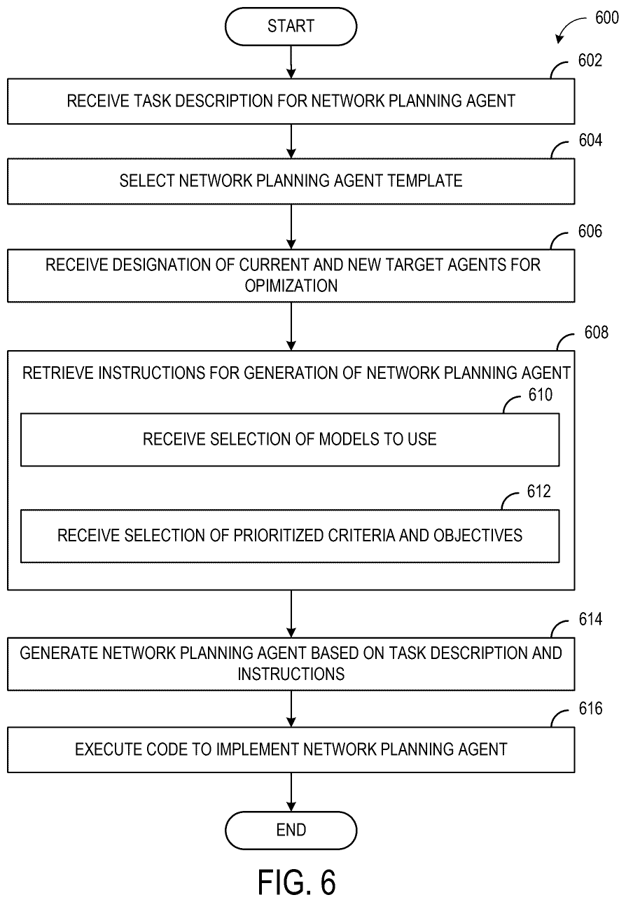

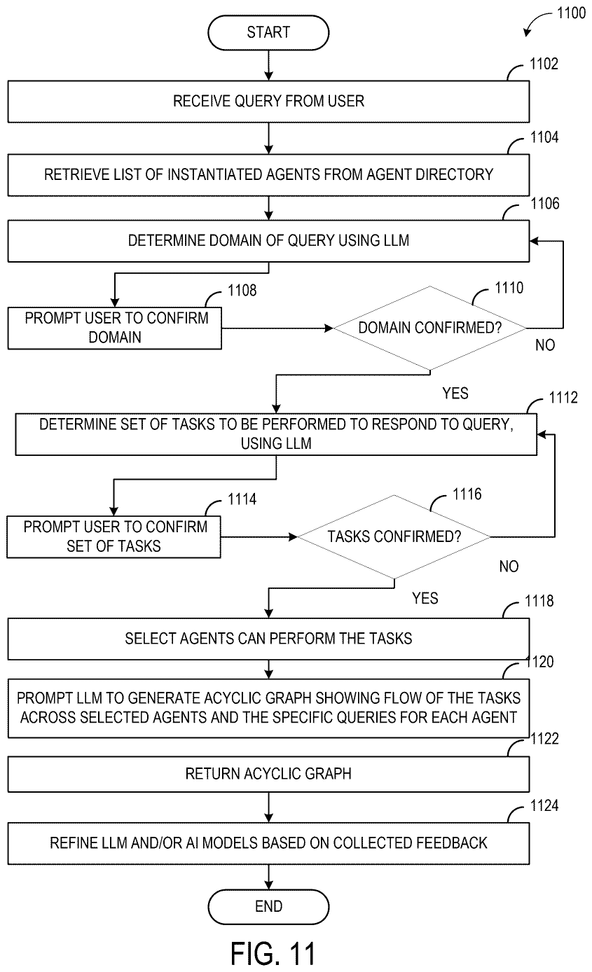

Non-transitory memory 106 may store a plurality of agents 108 that are generated by agent generator 102, an agent directory 109, a plurality of agent templates 110 that may be customized to create the agents 108, a prompt template library 111 used for addressing user queries, an AI service optimization module 112, and a custom AI module 114. Non-transitory memory 106 may include instructions for generating the plurality of agents 108 from task description 142 and instructions 144. Specifically, non-transitory memory 106 may include instructions that, when executed by processor 104, cause agent generator 102 to conduct one or more of the steps of method 300 for generating an agent, described in more detail below in reference to FIG. 3, as well as other methods described herein in reference to subsequent figures. For example, agents 108 may include one or more fact-checking agents 120, described in reference to FIG. 4; one or more resource allocation agents 122, described in reference to FIG. 5; one or more network planning agents 124, described in reference to FIG. 6; a selector agent 125, described in reference to FIG. 11; and an instructional assistance agent 126, which may aid user 101 in generating the instructions 144, based on task description 142 and user input of user 101. Selector agent 125 may be used to select an AI agent for performing a task from a plurality of AI agents listed in agent directory 109, which may include a list of various agents 108 that have been initiated and that may be performing tasks within agent generation system 100, and that may be available for performing additional tasks requested by user 101. For such purpose, selector agent 125 may select and submit various internal prompts (from prompt template library 111) to an LLM to determine a suitable agent for performing a task.

The plurality of agents 108 may be generated based on agent templates 110 using one or more of a plurality third-party LLMs 150, such as a first LLM 152, a second LLM 154, a third LLM 156, a fourth LLM 158, and a fifth LLM 160. In other embodiments, a greater or lesser number of LLMs may be included in third-party LLMs 150. The plurality of third-party LLMs 150 may include publicly available large language models (LLMs) such as those produced by OPENAI, META AI, AI21, ANTHROPIC, and/or COHERE, or other companies/projects. For example, in one embodiment, first LLM 152 may be a version of GPT (e.g., GPT4 or GPT 3.5 turbo) produced by OPENAI; second LLM 154 may be a version of Jurrassic by AI21; third LLM 156 may be a version of CLAUDE by ANTHROPIC; fourth LLM 158 may be a version of Coral by COHERE; and fifth LLM 160 may be a different LLM offered by a different service. For each of the third-party LLMs 150, information about the models may be retrieved or stored that may aid agent generator 102 in determining a most suitable LLM for a given task. The information may include, for example, descriptions of an LLM, a maximum number of tokens accepted by the LLM, training data of the LLM, etc.

The generation of an agent 108 may involve the use of one or more of a plurality of internal AI models 115 of agent generator 102 stored in custom AI module 114. Custom AI module 114 may include various internal AI models 115 of various types, including trained and/or untrained neural networks such as convolutional neural networks (CNNs), recurrent neural networks (RNNs), generative adversarial networks (GANs), or other types of neural networks; statistical models, or other models; and may further include various data, or metadata pertaining to the one or more internal AI models 115 stored therein. Custom AI module 114 may include training datasets for the one or more internal AI models 115 of custom AI module 114. The one or more internal AI models 115 may include AI models for determining an accuracy of work performed by the one or more agents; AI models for assessing various scenarios and performing simulations of different actions for planning purposes; AI models for determining the effects of generating new agents and inserting the new agents into a multi-agent workflow; AI models for determining how a workflow may be divided between a plurality of AI agents, and selecting an AI agent to perform a specific task within the workflow; and/or other types of AI models used for different purposes.

In various embodiments, AI service optimization module 112 may include instructions for determining a suitable third-party LLM 150 for generating a specific type of agent. For example, first LLM 152 may be suitable for generating a first agent based on a first set of instructions 144 and a first task description 142. Second LLM 154 may be suitable for generating a second agent based on a second set of instructions 144 and a second task description 142, but may not be suitable for generating the first agent. Third LLM 156 may be suitable for generating a third agent based on a third set of instructions 144 and a third task description 142, but may not be suitable for generating either of the first agent and the second agent. Fourth LLM 158 may be suitable for generating the first agent, but may not perform as well at generating the first agent as first LLM 152, and so on. Thus, when generating a new agent, AI service optimization module 112 may determine a most suitable third-party LLM 150 to be selected for the generation of the new agent. One or more models stored in AI service optimization module 112 may be used to determine the most suitable third-party LLM 150. In various embodiments, the most suitable third-party LLM 150 may be selected using a predictive machine learning (ML) model, such as a decision tree model. The top-performing third-party LLM 150 may be selected based at least partially on the information stored about the third-party LLMs 150.

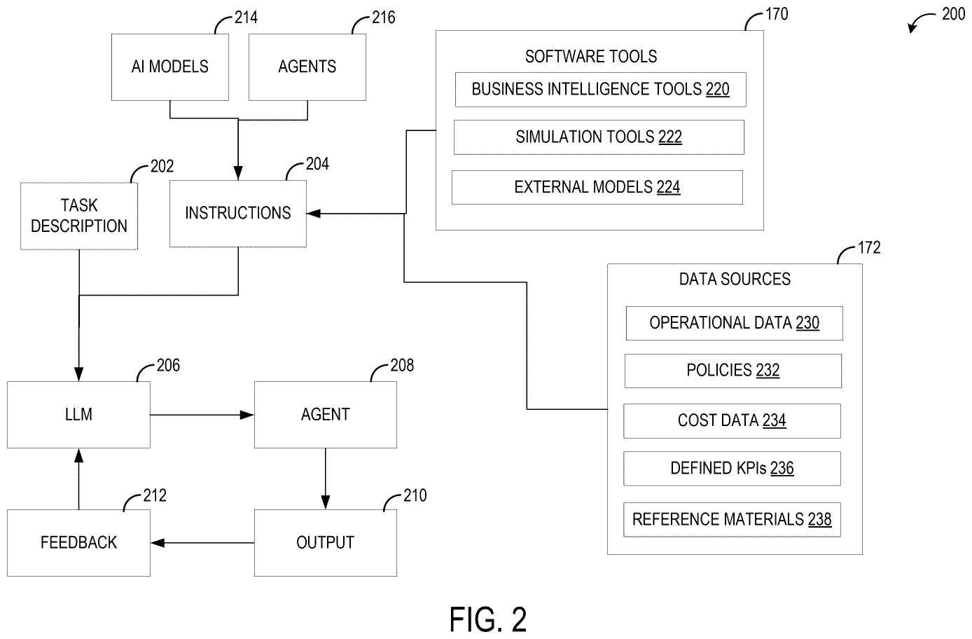

Agent generator 102 may be communicatively coupled (e.g., via a network) with one or more software tools 170 and one or more data sources 172, which may be used by agent generator 102 to generate an AI agent 108 and/or by one or more AI agents 108 when performing assigned tasks. The use of software tools 170 and data sources 172 are described in greater detail below in reference to FIG. 2.

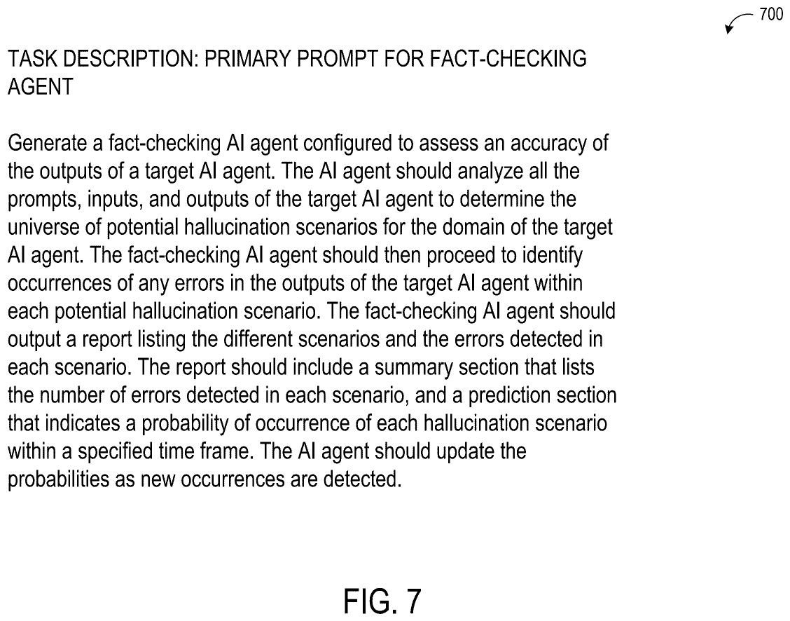

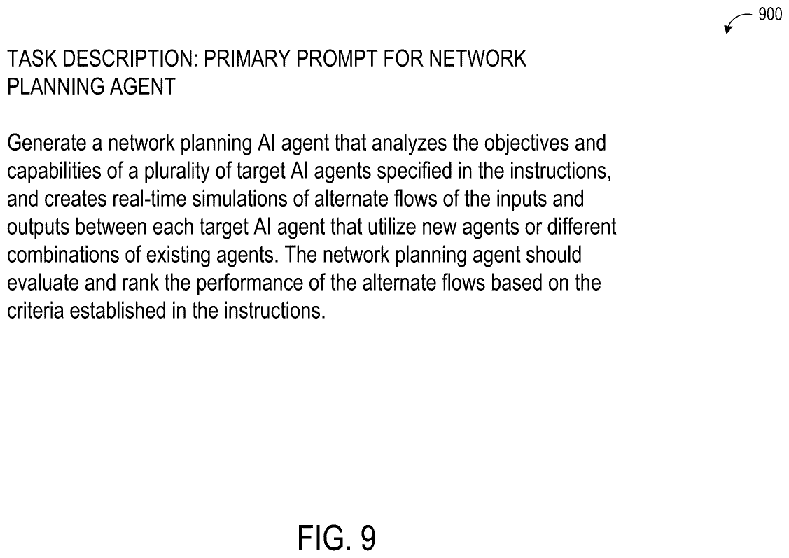

FIG. 2 shows a schematic diagram of an exemplary workflow 200 followed by an agent generator such as agent generator 102 of FIG. 1, when generating a new agent 208 (e.g., AI agent 108) assigned to perform a specific task defined by a user (e.g., a subject matter expert, user 101). Workflow 200 starts when a task description 202 and a corresponding set of instructions 204 (e.g., task description 142 and instructions 144 of FIG. 1, respectively) are received by the agent generator. Task description 122 may be written by the user and may define a main objective of the agent, including desired outputs of the agent. Examples of task description 202 are shown in FIGS. 7 and 9. Instructions 204 may include further instructions regarding how the agent is implemented. Instructions 204 may be generated by the user using tools provided by the agent generator. In various embodiments, the user may generate instructions 204 with the aid of an agent of the agent generator (e.g., instructional assistance agent 126), via a UI of the agent generator (e.g., UI 132), as described in greater detail below. The user may also specify a template to be used in designing a software implementation of agent 208.

The agent generator may convert task description 202 into a primary prompt, and may convert instructions 204 into a series of secondary prompts. The primary prompt and the secondary prompts may then be submitted to a selected LLM 206. An appropriate LLM 206 for generating the AI agent may be selected by an AI service optimization module (e.g., AI service optimization module 112) of the agent generator based on the task description. The AI service optimization module may select a most suitable LLM based on model pricing, model success rates on similar tasks or types of tasks, and/or other relevant information. In various embodiments, the AI service optimization module may rely on a predictive ML model such as a decision tree model to select the most suitable LLM.

By including the secondary prompts based on instructions 204 when submitting the primary prompt to selected LLM 206, a performance of selected LLM 206 and a performance of AI agent 208 generated by selected LLM 206 may be increased. For example, instructions 204 may instruct selected LLM 206 to create a multi-step action plan and a strategy for generating AI agent 208, which may result in a higher quality AI agent 208. Instructions 204 may further instruct selected LLM 206 to assume the role of a software engineer designing AI agent 208 when creating the multi-step action plan and strategy.

In various examples, the primary prompt and the secondary prompts may be submitted to selected LLM 206 as a series of chained prompts, where a result of a first prompt becomes an input to a subsequent prompt, which may also increase an accuracy and/or quality of the output of selected LLM 206 and/or AI agent 208. As used herein, accuracy and/or quality refer to a degree of success of AI agent 208 at performing a specific task defined in task description 202. The combination of task description 202 (primary prompt) and instructions 204 (secondary prompts) may result in selected LLM 206 generating a technically appropriate design of AI agent 208 that supports the desired functionality of AI agent 208 expressed in task description 202.

Instructions 204 may specify one or more AI models 214 (e.g., internal AI models 115) to be used by agent 208 in performing the assigned task. Instructions 204 may also specify one or more agents 216 (e.g., agents 108) previously created by the agent generator that agent 208 may interact with in performing the assigned task. For example, the assigned task may demand that agent 208 monitor one or more agents 216 to determine an accuracy of outputs of the one or more agents 216, as described in the method of FIG. 4. Alternatively, the assigned task may demand that agent 208 assess an efficiency of the one or more agents 216, as described in the method of FIG. 6. In other cases, instructions 204 may specify that agent 208 receive inputs from a first agent 216, or that an output 210 of agent 208 be sent to a second agent 216.

Instructions 204 may define one or more software tools 170 to be used or that may be used by selected LLM 206 in generating agent 208, and/or to be used by agent 208 in performing the assigned task. In various examples, the one or more software tools 170 may include commercially available tools or services provided via a cloud-based server and/or a network. For example, for a first task, instructions 204 may specify that agent 208 use one or more business intelligence tools 220, and may specify how the one or more business intelligence tools 220 may be accessed by agent 208 and instructions for using the one or more business intelligence tools 220 to perform the assigned task. For a second task, instructions 204 may specify that agent 208 use one or more simulation tools 222, and may specify how the one or more simulation tools 222 may be accessed by agent 208 and instructions for using the one or more simulation tools 222 to perform the assigned task. For a third task, instructions 204 may instruct agent 208 to use one or more external models 224 (e.g., external to the agent generation system and/or health care system), and may specify how the one or more external models 224 may be accessed by agent 208 and instructions for using the one or more external models 224 to perform the assigned task. Instructions 204 may further specify credentials, accounts, or other information for using software tools 170. Software tools 170 may be selected based on different criteria or demands specified in instructions 204, for example, latency, cost, etc.

It should be appreciated that the example tools provided herein are non-limiting and for illustrative purposes, and in different embodiments, different software tools 170, or a different number of software tools 170 may be provided. Further, instructions 204 may include instructions to determine when there is no appropriate tool for the task, and engage an appropriate resource, such as a human software engineer, to request the creation of a tool.

Instructions 204 may define one or more data sources 172 to be used by selected LLM 206 in generating agent 208, and/or to be used by agent 208 in performing the assigned task. The one or more data sources 172 may include operational data 230 of the health care system being analyzed by agent 208. For example, agent 208 may be tasked with analyzing decisions made within a hospital system, and instructions 204 may specify one or more databases including operational data of the hospital system relevant to the decisions.

The one or more data sources 172 may include one or more policies 232 to be adhered to by agent 208 when performing the assigned task. Policies 232 may include safety policies, security policies with respect to data accessed by agent 208 and recommendations made by agent 208, purchasing policies, and/or other types of corporate, organizational, or governmental policies relating to assigned task. In some examples, instructions may be provided to determine whether any policies that are added to the data sources are in conflict, and engage an appropriate human resource (e.g: legal, HR, regulatory) for resolution.

The one or more data sources 172 may include cost data 234 of various services and/or physical elements relating to the assigned task, such as pricing models, historical or current prices and costs, past and proposed budgets, and the like. For example, agent 208 may be assigned to review proposed purchases of medical equipment for a hospital unit, and provide options for how budgeted funds may be allocated.

The one or more data sources 172 may include sets of defined key performance indicators (KPIs) 236 associated with different products, services, and/or projects being carried out within a domain of agent 208 or the assigned task. Agent 208 may be tasked with determining a degree to which different KPIs 236 have been met.

The one or more data sources 172 may include various reference materials 238 that may be or are expected to be consulted by agent 208 during the performance of the assigned task. Reference materials 238 may include, for example, medical literature or guidelines, government regulations, technical specifications documents, user manuals, etc.

Instructions 204 may further specify credentials, accounts, or other information for using data sources 172. It should be appreciated that the example tools provided herein are non-limiting and for illustrative purposes, and in different embodiments, different data sources 172, or a different number of data sources 172 may be provided.

LLM 206 may output programming code for generating agent 208, and agent 208 may be activated to perform the assigned task by executing the programming code. In various examples, agent 208 may be activated within a test or playground environment, where an output 210 of agent 208 may be reviewed by the user to determine a degree of success of agent 208 at performing the assigned task. The user may provide feedback 212 on the performance of agent 208 on the assigned task. For example, the feedback may be provided via UI 132 of FIG. 1. The feedback may include suggested changes to task description 202 and/or instructions 204, or may be used by the agent generator to make changes to task description 202 and/or instructions 204. The updated task description 202 and/or instructions 204 may then be submitted to selected LLM 206, and agent 208 may be regenerated. In this way, agent 208 may be designed and implemented in an iterative and/or cyclical fashion until agent 208 achieves a threshold performance.

Referring now to FIG. 3, a high level method 300 is shown for an agent generator, such as agent generator 102 of FIG. 1, for generating an AI agent, such as agent 208 of FIG. 2. One or more steps of method 300 and the other methods included in this disclosure may be performed by a processor of the agent generator (e.g., processor 104) in accordance with instructions stored in a memory of the agent generator (e.g., non-transitory memory 106). The agent generator may rely on a plurality of third-party LLMs, such as third-party LLMs 150 of FIG. 1.

Method 300 starts at 302, where the method includes receiving a task description from a user of the agent generator. In various examples, the task description may be received by the agent generator via a UI displayed in a web browser, such as UI 132 of FIG. 1. For example, the task description may be saved as a document, and the document may be uploaded to the agent generator via the UI, or the task description may be copied/cut and pasted into the UI. The task description may establish the purpose or objective of the AI agent.

At 304, method 300 includes receiving instructions (instructions 204) for generating the agent. Receiving instructions for generating the agent include, at 306, receiving a selection of data sources (e.g., data sources 172) to make available to the agent, and/or informational resources to be used by the agent or that are available for the agent to use. The agent may perform the task described in the task description by analyzing data included in the data sources. The informational resources may include simulation tools, internal or external statistical, probabilistic, ML, or other types of models that may be used by the agent or that may rely on an output of the agent, business intelligence tools, and so on.

At 308, receiving instructions for generating the agent includes receiving an allocation of processing and memory resources available for performing the task. That is, an amount of processing and memory resources available to each AI agent may be constrained based on a type of analysis or task performed by the AI agent, an amount of overall processing and memory resources available at a time when the AI agent is created, a number of AI agents in an agentic system created by the agent generator, and/or other criteria. At a time of creation, each AI agent created by the agent generator may be allocated an amount of processing resources of processor 104 and memory resources of non-transitory memory 106 that may be used by the AI agent in performing tasks. Some AI agents may be allocated more processing resources than other AI agents. By constraining the processing and memory resources made available to each AI agent on an individual basis, a first efficiency of the agent generator at generating and managing the agents may be balanced against a second efficiency of the AI agents at performing their respective tasks. As a result, bottlenecks in coordinated tasks that rely on various AI agents may be prevented. For example, in an alternative implementation of an agentic system where such constraints were not imposed, an AI agent could be assigned a computationally heavy task that monopolizes the use of processor 104 and/or memory 106, such that a latency could be introduced in interactions with the user that could result in a decreased use of the agent generator.

At 310, receiving instructions for generating the agent includes receiving a selection of one or more other AI agents that may be of service to the agent or that may rely on outputs of the agent. For example, the agent may be tasked with monitoring a performance of a target agent, or an interaction between two target agents, etc.

At 312, receiving instructions for generating the agent includes receiving custom structural and functional guidelines for generating the agent. The structural and functional guidelines may be different for different types of agents. For example, the agent may be tasked with storing data, and the structural and functional guidelines may include instructions for creating new databases or database tables to store the data. The custom structural and functional guidelines may include formatting instructions, where data processing performed by the agent may include formatting data in a specific manner, or converting a first formatting of data into a second formatting of data, for example, for comparing two sets of data. The custom structural and functional guidelines may include specifications of amounts of memory to allocate for different processes, whether certain processes should be multi-threaded, whether user input may be received and how the user input may be used by the agent. In some examples, the custom structural and functional guidelines may specify logical components of the agent and interfaces with which they are connected or communicate, and the inputs or outputs of the components.

At 314, method 300 includes selecting a suitable template for implementing the agent. The suitable template may be selected based on the task description (e.g., the type of task), and the custom structural and functional guidelines for generating the agent received at 312. The templates may be provided by human experts with an understanding of the task and/or software implementation considerations.

At 316, method 300 includes selecting a most suitable LLM for generating the agent, and for the agent to use in performing the task, based on the task description and the instructions. As described above in reference to FIG. 2, the most suitable LLM for generating the agent may be selected from a set of candidate LLMs. Selecting the most suitable LLM may include using a base AI service application programming interface (API) for the selected LLM. The base AI service API may be also used by the agent generator to submit prompts to the selected LLM (e.g., selected LLM 206), and receive programming code for implementing the AI agent outputted by the selected LLM.

The most suitable LLM may be selected using one or more internal models of the agent generator. The internal models may include predictive ML models, pricing models, statistical models, probabilistic models, belief networks, neural networks, rules-based systems that rely on reference tables stored in memory, or a different type of model. In one embodiment, a random forest model is used to select the most suitable LLM from the set of LLMs. In another embodiment, a decision tree model is used to select the most suitable LLM from the set of LLMs. For example, various criteria of various different base AI service APIs may be inputted into the random forest or decision tree model to determine a relative suitability of each different LLM. The criteria may include success rates for previous LLMs used to generate similar types of AI agents for similar task descriptions. The criteria may also include per-token pricing or cost data of he LLMs; an execution time of the LLMs; how frequently the LLM has been selected for use on previous AI agents; an average number of errors recorded using the LLM over a predetermined time frame (e.g., one day); and/or other information. Based on the information retrieved by the decision tree model, the agent generator may determine a most suitable LLM to use to generate a highest-quality agent for a lowest cost.

At 318, method 300 includes converting the task description and the instructions into a series of prompts, and submitting the prompts to the selected LLM to generate programming code for implementing the agent. At 320, method 300 includes executing the programming code to create the agent.

At 322, method 300 includes registering the agent in an agent directory of the agent generator (e.g., agent directory 109 of FIG. 1). The agent directory may maintain a list of a plurality of instantiated AI agents in the agentic system created by the agent generator. The agent directory may be used by a selector agent, such as selector agent 125 of FIG. 1, to determine whether one or more existing AI agents may be used for a task requested by the user, rather than generating a new AI agent to perform the task. The selector agent may be configured to select a suitable AI agent for performing the task, as described in greater detail below in reference to FIG. 11.

At 324, method 300 optionally includes creating a representative pool of synthetic data to test agent performance in a playground environment. In other examples, the agent may not be tested prior to deployment, and may be deployed in an information ecosystem (e.g., a health care system) after creation.

As an example of how method 300 may be used, a manager of a hospital unit may generate an agent to analyze the efficiency of a patient downgrade recommendation system of the hospital that recommends when patients of the hospital unit are ready to be released from the hospital unit. The manager may log into the patient generator and configure the agent. The manager may enter into a UI of the patient generator an appropriate task description, that specifies that the agent should monitor inputs to the patient downgrade system, and predictions outputted by the patient downgrade recommendation system. The manager may launch an instructional assistance agent of the agent generator, which may interact with the manager via the UI. The instructional assistance agent may prompt the manager to enter in sources of data relied on by the patient downgrade recommendation system. In response to the manger providing a location of patient data, the instructional assistance agent may prompt the manager to enter in a location of one or more privacy and security policies that the agent should adhere to in handling the patient data. The instructional assistance agent may prompt the manager to enter in locations of medical guidelines, best practice documents, hospital release criteria and policies, etc. The instructional assistance agent may prompt the manager to specify one or more models to use to analyze the outputs of the patient downgrade recommendation system. For example, the manager may specify a classification model, and may specify in the instructions that the agent keep track of the recommendations outputted by the patient downgrade recommendation system and output a report that classifies the recommendations into categories using the classification model. The manager may further specify that the agent receive patient release data from a patient or bed management system of the unit, and report performance statistics of the patient downgrade recommendation system, such as a percentage of patient downgrade recommendations that resulted in releases. The manager may also specify one or more KPIs of the patient downgrade recommendation system, where the KPIs may include target percentages calculated by the agent. The agent generator may select an appropriate template for the agent based on the task, which may specify a general structure of the agent. The instructional assistance agent may prompt the manager to enter in a budget within which the agent should operate. The agent generator may then select an appropriate LLM to generate the agent, based on the budget, task description, and instructions, using a decision tree model. The agent generator may convert the task description and the instructions into a series of prompts, which may be chained prompts that describe a multi-step action plan. The agent generator may submit the prompts to the selected LLM, and the LLM may output programming code that can be used to generate the agent. The agent generator may store and compile the code at a predefined location within a memory of the agent generator (e.g., non-transitory memory 106). The agent generator may then prompt the manger to activate the agent via the UI. The manager may activate the agent by selecting a control element of the UI (e.g., a button), and the agent generator may execute the code to generate the agent. The agent may perform the assigned task. When the KPIs are met, the agent may output a notification to the manager. In this way, the manager can assess the performance of the patient downgrade recommendation system in an automated and programmatic fashion, without having to rely on technical staff or engineers.

FIGS. 4, 5, and 6 show specific methods for generating different exemplary agents using an agent generator such as agent generator 102, that may be considered customizations of method 300 of FIG. 3. Referring now to FIG. 4, a method 400 is shown for generating a fact-checking agent tasked with verifying an output of a target AI agent of the health care system. AI agents that rely on LLMs are capable of hallucination, where untrue “facts” generated by an AI agent may be invented, because LLMs ‘guess’ what a correct response to a prompt should be. Hallucinations can involve, but are not limited to, inventing dates, diseases, names, or other facts that either do not exist or are not relevant to an input prompt. Traditionally, solving this may include a manual task of secondary prompt development for the agent, where secondary prompts function as a sanity check step for the agent to fact check its work. An example of a secondary prompt is “Make sure that every appointment date you cited corresponds to an actual appointment this patient had”. However, this approach is problematic for a number of reasons. The secondary prompts may be most accurately written by an engineer, which means that an engineer may have to remember to write them, and to do so consistently. Also, the secondary prompts may rely on nuanced knowledge about what type of hallucination is likely to occur and a downstream impact and mitigation process. The secondary prompts may also be computationally expensive, increasing both financial cost and latency of the solution. This compounds for an agentic system including a plurality of AI agents.

As an alternative, one or more steps of method 400 may be used to generate fact-checking agent that verifies an output of the target AI agent in an automated manner. Method 400 begins at 402, where method 400 includes receiving a task description for the fact-checking agent from a user of the agent generator. The task description may include analyzing a plurality of prompts, inputs, and outputs of the target AI agent and automatically (e.g., without human intervention) generating a plurality of secondary prompts for fact-checking the outputs. More specifically, the fact-checking agent may be instructed to determine a universe of potential hallucination scenarios for a domain of the target AI agent, and determine a set of heuristics for determining a probability of occurrence of each hallucination scenario. The fact-checking agent may be instructed to estimate a severity of a downstream impact of a hallucination, and output a report indicating the probability of occurrence of each hallucination scenario. FIG. 7 shows an example task description 700 for generating the fact checking agent.

At 404, method 400 includes receiving a designation of a target AI agent to be fact-checked. At 406, method 400 includes selecting a fact-checking agent template from the plurality of agent templates stored in the agent generator. In various examples, the fact-checking agent template may be predefined. In some examples, subject matter experts and technical experts may work together to generate different types of templates that can be used to address various types of common demands and/or problems, such as verifying outputs of agents or models, monitoring the efficiency of agents or programs within the health care system, proposing how resources of the health care system may be allocated, etc. Once created, subject matter experts may generate agents of the different types of templates without consulting with the technical experts.

At 408, method 400 includes receiving instructions for generating the fact-checking agent. Receiving the instructions for generating the fact-checking agent may include, at 410, receiving a selection of data sources and resources to be used for fact-checking the target AI agent. The data sources may include all inputs into the target AI agent, and all outputs of the target AI agent. At 412, method 400 includes receiving instructions for where, how, when and how often fact-checking reports are generated. At 414 , method 400 includes receiving instructions for selecting a suitable LLM to be used by the agent, and instructions for how the secondary fact-checking prompts are to be generated. For example, the instructions may specify what types of questions are asked in the prompts with respect to the output of the target AI agent, and sample questions may be provided as examples. The instructions may include a budget to consider for the services of the selected LLM.

At 416, method 400 includes submitting the task description and instructions as prompts to the selected LLM to generate code for implementing the agent, and at 418, method 400 includes executing the code to implement the fact-checking agent. The agent will then inject itself as a ‘reviewer’ of the output of the target AI agent, based on a composite risk score heuristic that evaluates both probability of various types of hallucination and downstream impact severity. In some examples, the agent may leverage a mix of human-in-the-loop workflows and unsupervised learning to determine the severity of downstream impact of a hallucination. As a result, a significantly more comprehensive hallucination detection framework may be created that also optimizes for cost, latency, and compute resources.

As another example, FIG. 5 shows a method 500 for generating a resource allocation agent tasked with analyzing an allocation of resources within the health care system. Real-time planning within a health system is a complex multi-disciplinary engagement requiring knowledge of facility capacity, staff competency, patient criticality, and opportunity cost analysis (e.g., “what else could I be doing right now”). The resource allocation agent may be configured to take as input an operational request, such as “Can I admit a new patient into the ICU in the next six hours?”, and perform an analysis of how ICU resources are currently being used and predicted to be allocated over the defined time period. For such purpose, various simulation tools may be used to simulate and compare different scenarios to answer the operational request.

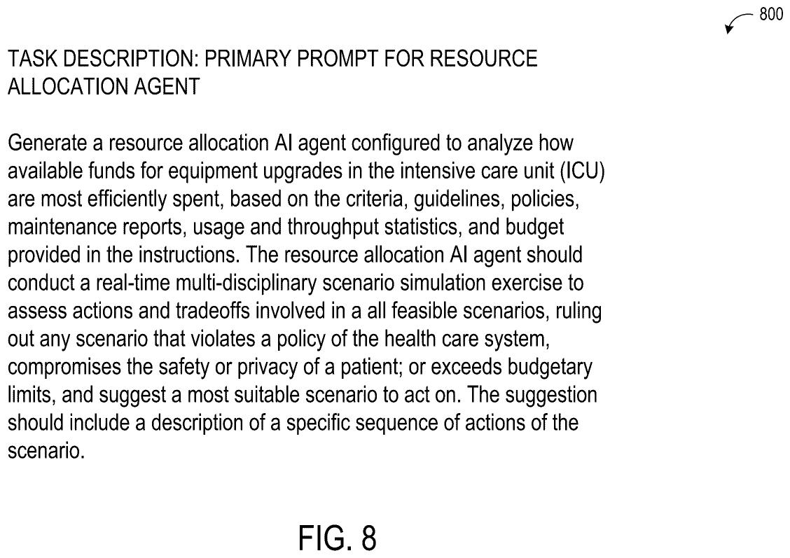

Method 500 begins at 502, where method 500 includes receiving a task description for the resource allocation agent from a user of the agent generator. The task description may specify that the resource allocation agent conduct a real-time multi-disciplinary scenario simulation exercise to assess actions and tradeoffs involved in a plurality of scenarios for an allocation of a specific set of resources described in the task description. For example, the resources may include funds for procuring certain types of medical equipment, software, hiring additional staff, etc. The task description may instruct the resource allocation agent to rule out any scenario that violates a policy of the health care system, compromises the safety or privacy of a patient; or exceeds budgetary limits. The task description may instruct the resource allocation agent to suggest a most suitable scenario to act on, and explain a specific sequence of actions of the scenario. In some examples, the resource allocation agent may be instructed to automatically execute some or all of the actions in that scenario without any human intervention or with human-in-the-loop workflows. FIG. 8 shows an example task description 800 for generating the resource allocation agent.

At 504, method 500 includes selecting a resource allocation agent template from the plurality of agent templates stored in the agent generator. At 506, method 500 includes receiving instructions for generating the resource allocation agent. Receiving the instructions for generating the resource allocation agent may include, at 508, receiving a description of resources, budgets, criterion, objectives, and priorities for performing the resource allocation task, as well as the sources of corresponding data and any models, software tools, etc. to be used as described in method 300.

At 510, receiving the instructions for generating the resource allocation agent may include receiving a specification of policies of the health care system to adhere to.

At 512, method 500 includes receiving instructions for refining the assessment process over time, based on defined KPIs and/or human feedback. In other words, the agent may be instructed to learn in real time to improve its planning ability by observing a range of factors, including but not limited to whether a proposed scenario is approved or rejected by any human supervisor, and an outcome of an execution of the scenario compared with KPIs such as throughput, patient satisfaction scores, revenue, etc.

At 514, method 500 includes submitting the task description and instructions as prompts to the selected LLM to generate code for implementing the resource allocation agent, and at 516, method 500 includes executing the code to implement the resource allocation agent. Method 500 ends.

FIG. 6 shows a method 600 for generating a network planning agent tasked with optimizing the performance of a plurality of target AI agents performing a respective plurality of tasks. As agentic systems grow in scale, a common problem becomes how to redesign existing agentic flows as new AI agents are created that may have utility within those flows. This type of insertion can have cascading effects both upstream and downstream of the new agent within the flow. Upstream agents may modify their output to be relevant to the new agent, beyond simply knowing to call the agent. Downstream agents may receive different inputs. To address this, one or more network planning agents may be generated using method 600 that may determine an optimal or most suitable flow of inputs and outputs across a network of agents.

Method 600 begins at 602, where method 600 includes receiving a task description for the network planning agent from a user of the agent generator. The task description may instruct the network planning agent to scan objectives and capabilities of a plurality of target AI agents, and create real-time simulations of alternate flows of the inputs and outputs of each target AI agent of the plurality of target AI agents that utilize new agents or different combinations of existing agents. The task description may instruct the network planning agent to evaluate the performance of the alternate flows based on one or more of quality of analysis performed by a target AI agent, task completion rate, latency, security risk, and patient safety risk, for example. FIG. 9 shows an exemplary task description 900 for generating the network planning agent.

The task description may also specify that the network planning agent identify inefficient flows, and/or provide suggestions for new agents to be created. This may result in a human-in-the-loop workflow, where a suggestion may be provided for different types of objectives. If there are sufficient templates already available, the network planning agent might automatically create the new desired agent and test its efficacy in the information ecosystem, communicating the results to a human with approval or veto abilities.

At 604, method 600 includes selecting a network planning agent template from the plurality of agent templates stored in the agent generator. At 606, method 600 includes receiving a designation of the plurality of target AI agents for which data flows are analyzed. The designation may include current AI agents, and new AI agents around which the alternate flows may be analyzed. The designation may include inputs and outputs of the target AI agents and instructions for accessing data of each of the target AI agents.

At 608, method 600 includes receiving instructions for generating the network planning agent. Receiving the instructions for generating the network planning agent may include, at 610, receiving a selection of models to use to assess the efficiency of the existing and alternate flows. The models may include internal models of the agent generator (e.g., AI models 214) and/or external models such as commercial models accessible over a network (e.g., external models 224).

At 612, receiving the instructions for generating the network planning agent may include receiving a selection of prioritized criteria and objectives for measuring the efficiency of the data flows. For example, for some data flows, patient safety may be prioritized, while for other data flows, a speed at which results are generated may be prioritized, or a minimization of costs.

At 614, method 600 includes submitting the task description and instructions as prompts to the selected LLM to generate code for implementing the network planning agent, and at 616, method 600 includes executing the code to implement the network planning agent. Method 600 ends.

In some examples, the network planning agent may be tasked with performing a cost forecasting and/or dynamic optimization of costs of operational costs of projects or aspects of the health care system. Generative AI systems (e.g., LLMs) can be inherently variable in their cost, because an underlying approach of generating probabilistic guesses for every character or pixel of the output varies from one run to the next. In cost-constrained environments, such as healthcare, most organizations have fixed pricing models that do not allow for such ambiguous costs. A common current practice is to forecast costs based on prior usage, and use the forecasted costs to estimate a future budget. However, in practice, such an approach may not be effective, because even if you can forecast costs accurately, you may not have a sufficient budget to handle the forecasted costs, and it may not be cheap to suddenly change the usage within a workflow in order to mitigate the costs.

To address this, in one example, the network planning agent may be instructed to dynamically and continuously plan workflows across a plurality of target AI agents based on fixed price constraints as well as performance constraints. For example, a financial planning agent can trend the cost of a plurality of specified agents within the network and estimate future costs per run. The financial planning agent can be instructed to collaborate with other workflow planning agents to model out alternative lower cost workflows between agents that can still achieve an ‘acceptable’ output, but at lower cost.

As an example, a backup lower cost agent could be generated using the agent generator that uses a lower cost LLM, which performs reasonably well but might not have the same fidelity of reasoning as a higher cost LLM. Based on how real life utilization is trending for a given financial period, the financial planning agent may be instructed to provide a directive to start using the backup agent in certain scenarios to ensure the system does not overrun budget constraints. Regardless of the agent used, the system can ensure that a quality and performance of the agent are acceptable, but higher cost models can perform beyond the minimum acceptable threshold when budget allows. This approach can be effective in healthcare settings where different visit types have different billable amounts, and in this environment, a financial analysis of expected revenue from a visit can inform the type of agents utilized in the workflow to support the visit.

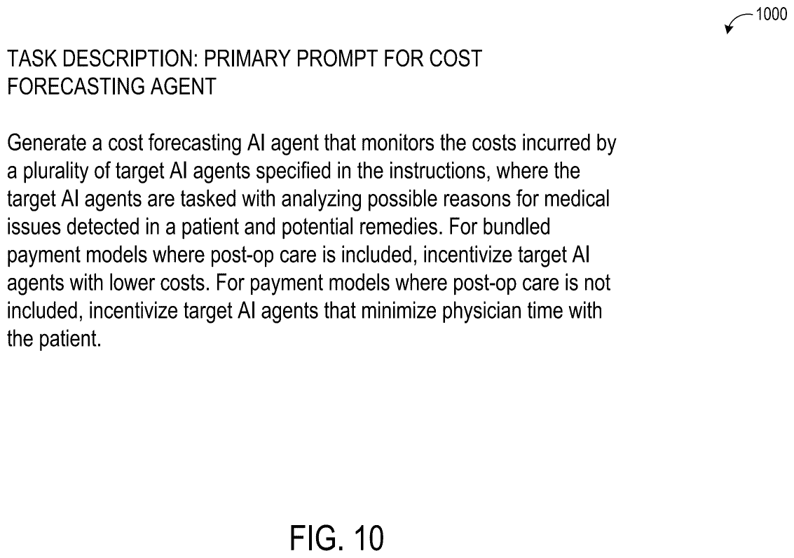

As another example, a patient undergoing an elective procedure on their knee who has unexpected recovery issues might elect to minimize a cost of using one or more agents, meaning, do less proactive analysis on possible reasons for issues and potential remedies, because follow-up visits are billable. However, a patient who has a knee surgery has part of a knee and hip bundled payment model will be billed the same amount, including all post-op care. In the latter model, the system may be incentivized to maximize agentic support and minimize physician time with the patient to diagnose recovery issues, since the physician time is not incrementally billable. FIG. 10 shows an exemplary task description 1000 for generating a cost forecasting agent.

Turning now to FIG. 11, a method 1100 is shown for selecting one or more existing AI agents (e.g., AI agents 108 of FIG. 1) of an AI agent generation system, such as AI agent generation system 100 of FIG. 1, to perform one or more tasks requested by a user of an agent generator (e.g., agent generator 102). That is, in the previous examples described above, agent generator 102 may be advantageously used to generate custom agents to perform certain requested tasks indicated by the user. However, in the event that various agents already exist when a task is requested, a selector agent such as selector agent 125 may be used to select one or more of the existing agents to perform a requested task. Additionally or alternatively, the AI agent generator may receive queries from the user, and the AI agent generator may answer the queries using one or more of the existing AI agents. The one or more existing AI agents may rely on one or more internal AI models (e.g., internal AI models 115) and/or one or more LLMs (e.g., third party LLMs 150) to answer the queries. The selector agent may determine one or more existing AI agents to most efficiently answer a query. Method 1100 may be performed by a processor such as processor 104 of agent generator 102, based on instructions stored in selector agent 125 of non-transitory memory 106 of agent generator 102.

Method 1100 begins at 1102, where method 1100 includes receiving a query from a user, for example, via a UI such as UI 132 of FIG. 1. The query may include a question that could be answered by an agentic system generated by the AI agent generator, depending on whether or not AI agents of the agentic system instantiated by the AI agent generation system can perform one or more tasks associated with the question. The query may additionally or alternatively indicate a desire of the user for a task to be performed.

At 1104, method 1100 includes retrieving a list of instantiated agents from the agent directory of the AI agent generator, such as agent directory 109 of FIG. 1. The instantiated agents may be registered in the agent directory upon their creation by the AI agent generation system, and may be removed from the agent directory upon their deletion by the AI agent generation system.

To determine one or more AI agents that may perform tasks associated with the query, the selector agent may iteratively submit a series of internal prompts (e.g., meaning, prompts not generated by the user) to an LLM of the one or more LLMs. In some examples, the prompts that are submitted may be based on predefined prompt templates stored in a memory of the AI generator, retrieved based on the query, and customized based on the query. That is, a library of prompt templates (e.g., prompt template library 111 of FIG. 1) may be manually populated, for example, in a database in the memory. Each prompt of the series of internal prompts may be submitted to the LLM, and the LLM may return a response to the selector agent. When the selector agent receives the response, the selector agent may request feedback on an accuracy of the response from the user, and reinforcement learning based on user feedback may be integrated into the agent selection process to increase a quality of the response of the LLM. Additionally or alternatively, in some examples, the accuracy of the response may be verified by a verification AI agent generated by the agent generator. The feedback, meaning the accuracy and/or validity of the response, may be used in real time to increase a specificity of the prompts and/or collected and stored in the memory to be used to retrain and/or refine the LLM and/or internal AI models of the agent generator. This is described in detail below with respect to exemplary steps 1106 to 1120 of method 1100.

At 1106, method 1100 includes determining a domain of the query, using an LLM. For example, the query may reference cancer, such as, “Are there any malignant tumors present in the referenced image.” Determining the domain of the query may include retrieving a prompt template from the prompt template library, creating a customized prompt using the prompt template based on the query, and submitting the customized prompt to the LLM. For example, a retrieved prompt template may be “Determine if the query is regarding [cancer type1] or [cancer type 2].” The selector agent may determine what cancer types might be referenced, for example, based on previous (e.g., historical) queries submitted by the user. A resulting customized prompt may be “Determine if the query is about prostate cancer or breast cancer.” The customized prompt may be submitted to the LLM. The LLM may respond with an indication that the query is concerning a possible breast cancer. Prior to continuing, the selector agent may prompt the user to confirm the domain. For example, the selector agent may ask the user, “Your query appears to be in relation to breast cancer. Is this correct?”

Such an approach may rely on the LLM to manage the relationship between concepts such as “prostate”, “breast”, “cancer”, and “tumor”. In various examples, an embedding model may be used to create a higher dimension representation of the query and the internal prompts. The higher dimensions enable weighted distances between words and characters in the query. These distances may then be compared with a detailed description of all the agents that are available, which is also represented in higher dimensions, as described further below.

At 1108, method 1100 includes prompting the user to confirm and/or provide first feedback on the domain determined at 1106, and at 1110, method 1100 includes determining whether the domain is confirmed by the feedback of the user.

If at 1110 the domain is not confirmed by the user, method 1100 proceeds back to 1106, and a different domain of the query may be determined using the LLM and/or AI models, where a different prompt may be submitted to the LLM. The different prompt may be generated based on the first feedback. Alternatively, if at 1110 the domain is confirmed by the user feedback, method 1100 proceeds to 1112. The feedback may be stored in the memory.

At 1112, method 1100 includes determining a set of tasks to be performed to respond to the query. To determine the set of tasks, a prompt may be submitted to the LLM instructing the LLM to identify the set of tasks, where the prompt is based on the query, the domain, and the first feedback. The prompt may be generated using a prompt template of the prompt template library. In some examples, the set of tasks to be performed may be determined by the selector agent based at least partly on medical reference guidelines stored in the memory. For example, the selector agent may retrieve a prompt template such as, “consult the medical reference guidelines to determine a first set of probable tasks for [query]. Then review historical examples of tasks that were performed for similar queries, to determine a second set of probable tasks for [query]. Then compare the first set of probable tasks and the second set of probable tasks to determine an overlap. If an overlap is detected, indicate the tasks included in both of the first set of probable tasks and the second set of probable tasks.” The selector agent may generate the respective customized query, and receive a response from the LLM with a set of candidate tasks to perform. The selector agent may then prompt the user to provide feedback, such as, “Based on medical reference guidelines and past queries, it seems that answering your query may entail [set of tasks]. Is this correct?”

At 1114, method 1100 includes prompting the user to confirm and/or provide second feedback on the tasks determined at 1112. At 1116, method 1100 includes determining whether the set of tasks are confirmed by the user feedback. If at 1116 it is determined that the tasks are not confirmed, method 1100 proceeds back to 1112, where a different prompt may be submitted to the LLM, where the different prompt may include or be based on the second feedback. If at 1116 it is determined that the tasks are confirmed, method 1100 proceeds to 1118.

At 1118, method 1100 includes selecting one or more agents of the list of instantiated AI agents retrieved from the agent directory to perform the set of tasks confirmed by the user. The selector agent may submit a prompt to the LLM requesting a list of suitable agents for performing the tasks. The plurality of agents listed in the agent directory may include various descriptors and attributes that can be leveraged to make the selection.

In other words, each agent of the plurality of agents may include a detailed description of the capabilities of the agent, including the kinds of tasks the agent is suitable for, the specific data sets the agent relies on to access to perform its tasks, a collection of tools the agent may use depending on a type of analysis performed by the agent, and a historical performance scoring of the agent that includes subjective metrics (quality scoring by humans & AI agents for accuracy, consistency, relevance, etc.), as well as objective metrics (latency, total runtime, memory usage, CPU usage, logged error rate, etc.). The descriptors may be included in relevant reference fields of the agent, and/or may be included in the agent directory.

As an example, an agent that is focused on image analysis for breast cancer may include descriptors for an imaging modality used, a size range of lesions or tumors that the agent can detect, one or more anatomical regions that the agent may analyze, one or more stage(s) of cancer that it may detect, and/or other details depending on what the agent has been specifically trained for. The descriptions included in each agent may enable the selector agent/LLM to process a query and use an embedding model to analyze a semantic similarity of various demands of the query with the capabilities of known agents in the directory, and make an optimal selection based on the semantic similarity, or reject the query because no appropriate agents exist to address the query.

Thus, at each step in the procedure described above, feedback is collected from the user on each internal “thought” the AI agent has, each time the user is prompted. The feedback may be stored in the memory to use to further refine/retrain the LLM and/or internal AI models. The feedback may also be used to refine successive prompts, using reinforcement learning. In the example above, a first thought might be “is this about prostate cancer or breast cancer”, while a second thought might be “which tasks are relevant to breast cancer”. The user's feedback can either be automatically interpreted by the system, meaning without human involvement, or in some cases manually interpreted by technical users (machine learning engineers) to apply tuning to the prompt. In the automated version, the selector agent may modify the original prompt leveraging the user's feedback. For example, the selector agent might ask the LLM to append user feedback to the end of the prompt, or rewrite the prompt based on the feedback. Additionally or alternatively, the selector agent may show the query and an analysis of the query by an AI agent as an example of ‘good’ or ‘bad, based on the collected feedback. Such a workflow generates an automated way to develop ‘few-shot’ training of prompts, but without relying on machine learning engineers to write the prompts. In this way, a currently laborious agent development process may be made more efficient by removing a reliance on a manual determination of what agents are relevant to a given query (manual agentic flow design), and instead offloading that task to the selector agent.

At 1120, method 1100 includes prompting the LLM to generate an acyclic graph showing a flow of the tasks across the selected agents, and the specific queries to be submitted to each AI agent of the selected agents. In some examples, a dedicated AI agent may be assigned to detect flaws in the sequence and tasks described by the acyclic graph. If flaws are detected, the LLM may be prompted to regenerate the acyclic graph.

At 1122, method 1100 includes returning an acyclic graph. The acyclic graph may show an assignment of the tasks to the selected AI agents, and specific instructions submitted to the selected AI agents to perform the tasks. The acyclic graph may be used by the agent generator to assign the tasks described by the acyclic graph to the selected AI agents, sequentially or in parallel, and formulate a response to the user based on the performance of the tasks by the selected AI agents.

At 1124, method 1100 includes refining the LLM and/or the AI models based on feedback collected from the user, and method 1100 ends.

Thus, methods and systems are provided for automatically generating an AI agent using one or more LLMs, based on functional instructions provided by a subject matter expert without the input of technical or software engineering experts. The subject matter expert may submit a task description and one or more additional instructions for generating the AI agent to an automated AI agent generator. The AI agent generator select an appropriate LLM, and may submit the task description and the additional instructions as prompts to the selected LLM to generate the AI agent. When generating the AI agent, the LLM may use resources, data, and tools provided in the instructions. Additionally or alternatively, the subject matter expert may submit a query to the AI agent generator, and the AI agent generator may use a selector agent to select one or more AI agents of a plurality of AI agents of an existing agentic system to answer the query or to perform tasks included in the query. The selector agent may follow a selection process that includes breaking the query into components, addressing the components sequentially, and consulting with the subject matter expert to provide feedback on progress prior to continuing with a subsequent component. In this way, a capacity or tendency of the LLM to extrapolate outside the boundaries of query and/or hallucinate in its responses may be restricted and more tightly controlled than in an alternative procedure where the subject matter expert is not consulted. As a result, an ultimate response to the query generated by the agents selected by the selector agent may be more accurate.

The technical effect of using the proposed agent generator to generate custom AI agents to perform a task, and/or to select custom AI agents of an existing agentic system to perform the task or answer a query, is that an overall consumption of resources by the LLM may be advantageously reduced. To respond to prompts, the LLM converts the prompts and any additional context (e.g., secondary prompts) into a high-dimensional vector (e.g., an embedding). The high-dimensional vector is then compared with content made available to the LLM as training data, and content that matches the high-dimensional vector is used to formulate a response, based on similarity metrics. Applying the similarity metrics to high-dimensional data is a computationally demanding task, which consumes processing resources at a high rate. An amount of the processing resources consumed can be reduced by increasing a specificity or accuracy of the prompts submitted to the LLM. That is, when a prompt for desired information is poorly constructed, a user may have to rewrite and resubmit the prompt various times to obtain the desired information. Similarly, when a prompt to create an agent configured to perform a task is poorly constructed, a user may have to rewrite and resubmit the prompt various times to create the agent. Each time a prompt is resubmitted, processing resources are wasted. To reduce the amount of processing resources that are wasted, the disclosed agent generator employs a series of methods to aid the user, specifically, a non-technical user, in creating precise and tightly controlled prompts that result in the creation or selection of agents configured to perform tasks with a higher degree of specificity than may be obtained without using the agent generator. As a result, an amount of time and processing resources consumed by the LLM to generate or select the agent may be reduced.

Additionally, instances of hallucination by the LLM may result in additional correction of the prompts, which lengthens the agent generation process and increases the consumption of processing resources. By dividing user queries into components that are individually addressed, and incorporating the validation of each individual component by the user into the prompt generation process, a tendency of the LLM to hallucinate may be reduced, resulting in more accurate answers with a decreased amount of computation.

The disclosure also provides support for an artificial intelligence (AI) agent generation system, comprising: an agent generator including a processor communicably coupled to a non-transitory memory including instructions that when executed, cause the processor to: receive a task description of a computerized task to be performed within a health care system and instructions for generating an AI agent to perform the task from a user of the agent generator, receive a selection of a template for the AI agent of a plurality of templates from the user, select a large language model (LLM) of a plurality of LLMs stored in a cloud, based on the task description and the instructions, submit one or more prompts including the task description and the instructions to the selected LLM to generate a program for creating the AI agent, based on the selected template, and execute the program to generate the AI agent and allocate processing resources to the AI agent, store the program and/or the AI agent in the non-transitory memory as part of an agentic system, the agentic system including a plurality of AI agents having different allocations of processing resources, and perform the computerized task using the generated AI agent. In a first example of the system, further instructions are stored in the non-transitory memory that when executed, cause the processor to select the LLM based on at least one of: a pricing of AI services including the LLM, a success rate of the LLM on similar types of tasks, or an output of a predictive machine learning (ML) model. In a second example of the system, optionally including the first example, the agent generator includes an instructional assistance AI agent configured to aid the user in generating the instructions, and the instructions are received via a user interface (UI) of the agent generator as a result of an interaction between the user and the instructional assistance AI agent. In a third example of the system, optionally including one or both of the first and second examples, the instructions for generating the AI agent include at least one of: a selection of one or more data sources and informational resources available for the AI agent to use, an allocation of processing and memory resources available to be used by the AI agent in performing the task, a specification of one or more target agents that the AI agent interacts with in performing the task, and structural and/or functional guidelines for implementing the AI agent. In a fourth example of the system, optionally including one or more or each of the first through third examples, the data sources include at least one of: operational data of the health care system, policies of the health care system, cost and/or pricing data of products, services, and programs of the health care system, key performance indicators (KPIs) defined for the products, services, and programs, reference materials including medical literature and guidelines, government regulations, technical specifications documents, and user manuals. In a fifth example of the system, optionally including one or more or each of the first through fourth examples, the AI agent is one of: a fact-checking agent tasked with verifying an output of a target AI agent of the health care system, a resource allocation agent tasked with analyzing an allocation of resources within the health care system, and a network planning agent tasked with optimizing a performance of a plurality of target AI agents performing a respective plurality of tasks. In a sixth example of the system, optionally including one or more or each of the first through fifth examples, the AI agent is a selector agent configured to: receive a query from the user, retrieve a list of AI agents instantiated within the agentic system created by the agent generator, determine a domain of the query using the LLM, determine one or more tasks to be performed to respond to the query, based on the domain, select one or more AI agents of the list of AI agents that can perform the one or more tasks, and prompt the LLM to generate an acyclic graph showing an assignment of the tasks to the selected AI agents and specific queries assigned to each AI agent of the selected AI agents, wherein the user is prompted to confirm the domain prior to the selector agent determining the one or more tasks, and the user is prompted to confirm the one or more tasks prior to selecting the one or more AI agents to perform the one or more tasks.

The disclosure also provides support for a method for generating an artificial intelligence (AI) agent to perform a computerized task within a health care system, the method comprising: receiving, at an automated AI agent generator of the health care system, a description of a task and instructions for generating an AI agent to perform the task from a user of the health care system, selecting a large language model (LLM) of a plurality of LLMs stored in a cloud, based on the task description and the instructions, submitting one or more prompts including the task description and the instructions to the selected LLM to generate a program for creating the AI agent, executing the program to generate the AI agent, and performing the task using the generated AI agent. In a first example of the method, the instructions for generating the AI agent to perform the task are generated by the user via a user interface of the AI agent generator with the aid of an instructional assistance agent of the AI agent generator that prompts the user to provide one or more of: a template for implementing the AI agent, a first selection of one or more data sources available for the AI agent to use, a second selection of one or more resources available to be used by the AI agent in performing the task, a specification of one or more target agents that the AI agent interacts with in performing the task, and structural and/or functional guidelines for implementing the agent. In a second example of the method, optionally including the first example, the one or more prompts include a specification of a template for the AI agent selected from a plurality of templates by the user. In a third example of the method, optionally including one or both of the first and second examples, the AI agent is a fact-checking agent tasked with verifying an output of a target AI agent of the health care system, and the task description includes: analyzing a plurality of prompts, inputs, and outputs of the target AI agent, generating a plurality of secondary prompts for fact-checking the outputs, determining a universe of potential hallucination scenarios for a domain of the target AI agent, determining a set of heuristics for determining a probability of occurrence of each hallucination scenario, estimate a severity of a downstream impact of a hallucination, and outputting a report indicating the probability of occurrence of each hallucination scenario. In a fourth example of the method, optionally including one or more or each of the first through third examples, the AI agent is a resource allocation agent tasked with analyzing an allocation of resources within the health care system, and the task description includes: conducting a real-time multi-disciplinary scenario simulation exercise to assess actions and tradeoffs involved in a plurality of scenarios for the allocation of resources, ruling out any scenario that violates a policy of the health care system, suggesting a most suitable scenario to act on, and explaining a specific sequence of actions of the scenario. In a fifth example of the method, optionally including one or more or each of the first through fourth examples, the AI agent is a network planning agent tasked with optimizing a performance of a plurality of target AI agents performing a respective plurality of tasks, and the task description includes: scanning objectives and capabilities of the plurality of target AI agents, creating real-time simulations of alternate flows of inputs and outputs of each target AI agent of the plurality of target AI agents that utilize new agents or different combinations of existing agents, and evaluating the performance of the alternate flows based on one or more of quality of analysis performed by a target AI agent, task completion rate, latency, security risk, and patient safety risk. In a sixth example of the method, optionally including one or more or each of the first through fifth examples, the task description of the network planning agent includes dynamically and continuously planning workflows across the plurality of target AI agents based on fixed price constraints. In a seventh example of the method, optionally including one or more or each of the first through sixth examples, the method further comprises: creating a representative pool of synthetic data to test the AI agent in a playground environment.

The disclosure also provides support for a method for responding to a query submitted by a user of a computational system using one or more AI agents of an agentic system generated by an agent generator of the computational system, the method comprising: retrieving a list of AI agents instantiated within the agentic system from a memory of the agent generator, determining a domain of the query using a large language model (LLM), determining one or more tasks to be performed to respond to the query, using the LLM, selecting one or more AI agents of the list of AI agents that can perform the one or more tasks, assigning the tasks to the selected AI agents, and formulating a response to the user based on a performance of the tasks by the selected AI agents, wherein: the user is prompted to provide first feedback on the domain prior to determining the one or more tasks, the first feedback used to refine a first successive prompt to the LLM to determine the domain or the one or more tasks, and the user is prompted to provide second feedback on the one or more tasks prior to selecting the one or more AI agents to perform the one or more tasks, the second feedback used to refine a second successive prompt to the LLM to determine the one or more tasks or select the one or more AI agents. In a first example of the method, determining the domain of the query using the LLM further comprises: retrieving a predefined prompt template from the memory, based on the query, creating a customized prompt from the retrieved predefined prompt template based on the query, submitting the customized prompt to the LLM. In a second example of the method, optionally including the first example, each AI agent of the list of AI agents includes a description of capabilities of each AI agent, and selecting the one or more AI agents of the list of AI agents that can perform the one or more tasks further comprises using an embedding model to analyze a semantic similarity of demands of the query with the capabilities of each AI agent, and make a selection based on the semantic similarity. In a third example of the method, optionally including one or both of the first and second examples, refining the first successive prompt based on the first feedback further comprises including in the prompt the query and an analysis of the query by the LLM as an example of a “good” or “bad” analysis, based on the first feedback. In a fourth example of the method, optionally including one or more or each of the first through third examples, the method further comprises: verifying an accuracy of the response generated by the LLM using a verification AI agent generated by the agent generator.

When introducing elements of various embodiments of the present disclosure, the articles “a,” “an,” and “the” are intended to mean that there are one or more of the elements. The terms “first,” “second,” and the like, do not denote any order, quantity, or importance, but rather are used to distinguish one element from another. The terms “comprising,” “including,” and “having” are intended to be inclusive and mean that there may be additional elements other than the listed elements. As the terms “connected to,” “coupled to,” etc. are used herein, one object (e.g., a material, element, structure, member, etc.) can be connected to or coupled to another object regardless of whether the one object is directly connected or coupled to the other object or whether there are one or more intervening objects between the one object and the other object. In addition, it should be understood that references to “one embodiment” or “an embodiment” of the present disclosure are not intended to be interpreted as excluding the existence of additional embodiments that also incorporate the recited features.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, the examples and embodiments, in all respects, are meant to be illustrative only and should not be construed to be limiting in any manner.

1. An artificial intelligence (AI) agent generation system, comprising:
an agent generator including a processor communicably coupled to a non-transitory memory including instructions that when executed, cause the processor to:
receive a task description of a computerized task to be performed within a health care system and instructions for generating an AI agent to perform the task from a user of the agent generator;
receive a selection of a template for the AI agent of a plurality of templates from the user;
select a large language model (LLM) of a plurality of LLMs stored in a cloud, based on the task description and the instructions;
submit one or more prompts including the task description and the instructions to the selected LLM to generate a program for creating the AI agent, based on the selected template; and
execute the program to generate the AI agent and allocate processing resources to the AI agent;
store the program and/or the AI agent in the non-transitory memory as part of an agentic system, the agentic system including a plurality of AI agents having different allocations of processing resources; and
perform the computerized task using the generated AI agent.

2. The AI agent generation system of claim 1, wherein further instructions are stored in the non-transitory memory that when executed, cause the processor to select the LLM based on at least one of:
a pricing of AI services including the LLM;
a success rate of the LLM on similar types of tasks; or
an output of a predictive machine learning (ML) model.

3. The AI agent generation system of claim 1, wherein the agent generator includes an instructional assistance AI agent configured to aid the user in generating the instructions, and the instructions are received via a user interface (UI) of the agent generator as a result of an interaction between the user and the instructional assistance AI agent.

4. The AI agent generation system of claim 1, wherein the instructions for generating the AI agent include at least one of:
a selection of one or more data sources and informational resources available for the AI agent to use;
an allocation of processing and memory resources available to be used by the AI agent in performing the task;
a specification of one or more target agents that the AI agent interacts with in performing the task; and
structural and/or functional guidelines for implementing the AI agent.

5. The AI agent generation system of claim 4, wherein the data sources include at least one of:
operational data of the health care system;
policies of the health care system;
cost and/or pricing data of products, services, and programs of the health care system;
key performance indicators (KPIs) defined for the products, services, and programs;
reference materials including medical literature and guidelines, government regulations, technical specifications documents, and user manuals.

6. The AI agent generation system of claim 1, wherein the AI agent is one of:
a fact-checking agent tasked with verifying an output of a target AI agent of the health care system;
a resource allocation agent tasked with analyzing an allocation of resources within the health care system; and
a network planning agent tasked with optimizing a performance of a plurality of target AI agents performing a respective plurality of tasks.

7. The AI agent generation system of claim 1, wherein the AI agent is a selector agent configured to:
receive a query from the user;
retrieve a list of AI agents instantiated within the agentic system created by the agent generator;
determine a domain of the query using the LLM;
determine one or more tasks to be performed to respond to the query, based on the domain;
select one or more AI agents of the list of AI agents that can perform the one or more tasks; and
prompt the LLM to generate an acyclic graph showing an assignment of the tasks to the selected AI agents and specific queries assigned to each AI agent of the selected AI agents;
wherein the user is prompted to confirm the domain prior to the selector agent determining the one or more tasks, and the user is prompted to confirm the one or more tasks prior to selecting the one or more AI agents to perform the one or more tasks.

8. A method for generating an artificial intelligence (AI) agent to perform a computerized task within a health care system, the method comprising:
receiving, at an automated AI agent generator of the health care system, a description of a task and instructions for generating an AI agent to perform the task from a user of the health care system;
selecting a large language model (LLM) of a plurality of LLMs stored in a cloud, based on the task description and the instructions;
submitting one or more prompts including the task description and the instructions to the selected LLM to generate a program for creating the AI agent;
executing the program to generate the AI agent; and
performing the task using the generated AI agent.

9. The method of claim 8, wherein the instructions for generating the AI agent to perform the task are generated by the user via a user interface of the AI agent generator with the aid of an instructional assistance agent of the AI agent generator that prompts the user to provide one or more of:
a template for implementing the AI agent;
a first selection of one or more data sources available for the AI agent to use;
a second selection of one or more resources available to be used by the AI agent in performing the task;
a specification of one or more target agents that the AI agent interacts with in performing the task; and
structural and/or functional guidelines for implementing the agent.

10. The method of claim 8, wherein the one or more prompts include a specification of a template for the AI agent selected from a plurality of templates by the user.

11. The method of claim 8, wherein the AI agent is a fact-checking agent tasked with verifying an output of a target AI agent of the health care system, and the task description includes:
analyzing a plurality of prompts, inputs, and outputs of the target AI agent;
generating a plurality of secondary prompts for fact-checking the outputs;
determining a universe of potential hallucination scenarios for a domain of the target AI agent;
determining a set of heuristics for determining a probability of occurrence of each hallucination scenario;
estimate a severity of a downstream impact of a hallucination; and
outputting a report indicating the probability of occurrence of each hallucination scenario.

12. The method of claim 8, wherein the AI agent is a resource allocation agent tasked with analyzing an allocation of resources within the health care system, and the task description includes:
conducting a real-time multi-disciplinary scenario simulation exercise to assess actions and tradeoffs involved in a plurality of scenarios for the allocation of resources;
ruling out any scenario that violates a policy of the health care system;
suggesting a most suitable scenario to act on; and
explaining a specific sequence of actions of the scenario.

13. The method of claim 8, wherein the AI agent is a network planning agent tasked with optimizing a performance of a plurality of target AI agents performing a respective plurality of tasks, and the task description includes:
scanning objectives and capabilities of the plurality of target AI agents;
creating real-time simulations of alternate flows of inputs and outputs of each target AI agent of the plurality of target AI agents that utilize new agents or different combinations of existing agents; and
evaluating the performance of the alternate flows based on one or more of quality of analysis performed by a target AI agent, task completion rate, latency, security risk, and patient safety risk.

14. The method of claim 13, wherein the task description of the network planning agent includes dynamically and continuously planning workflows across the plurality of target AI agents based on fixed price constraints.

15. The method of claim 8, further comprising creating a representative pool of synthetic data to test the AI agent in a playground environment.

16. A method for responding to a query submitted by a user of a computational system using one or more AI agents of an agentic system generated by an agent generator of the computational system, the method comprising:
retrieving a list of AI agents instantiated within the agentic system from a memory of the agent generator;
determining a domain of the query using a large language model (LLM);
determining one or more tasks to be performed to respond to the query, using the LLM;
selecting one or more AI agents of the list of AI agents that can perform the one or more tasks;
assigning the tasks to the selected AI agents; and
formulating a response to the user based on a performance of the tasks by the selected AI agents;
wherein:
the user is prompted to provide first feedback on the domain prior to determining the one or more tasks, the first feedback used to refine a first successive prompt to the LLM to determine the domain or the one or more tasks; and
the user is prompted to provide second feedback on the one or more tasks prior to selecting the one or more AI agents to perform the one or more tasks, the second feedback used to refine a second successive prompt to the LLM to determine the one or more tasks or select the one or more AI agents.

17. The method of claim 16, wherein determining the domain of the query using the LLM further comprises:
retrieving a predefined prompt template from the memory, based on the query;
creating a customized prompt from the retrieved predefined prompt template based on the query;
submitting the customized prompt to the LLM.

18. The method of claim 16, wherein each AI agent of the list of AI agents includes a description of capabilities of each AI agent, and selecting the one or more AI agents of the list of AI agents that can perform the one or more tasks further comprises using an embedding model to analyze a semantic similarity of demands of the query with the capabilities of each AI agent, and make a selection based on the semantic similarity.

19. The method of claim 16, wherein refining the first successive prompt based on the first feedback further comprises including in the prompt the query and an analysis of the query by the LLM as an example of a “good” or “bad” analysis, based on the first feedback.

20. The method of claim 16, further comprising verifying an accuracy of the response generated by the LLM using a verification AI agent generated by the agent generator.
